(19) United States
(12) Patent Application Publication
(10) Pub. No.: US 2019/0227552 A1
(43) Pub. Date: Jul. 25, 2019

(54) VEHICLE CONTROL DEVICE

(71) Applicant: HONDA MOTOR CO., LTD., MINATO-KU, TOKYO (JP)

(72) Inventor: Daichi KATO, WAKO-SHI, SAITAMA-KEN (JP)

(21) Appl. No.: 16/336,780

(22) PCT Filed: Sep. 28, 2016
(86) PCT No.: PCT/JP2016/078554

§ 371 Date: Mar. 26, 2019

(51) Int. Cl. G05D 1/00; G05D 1/02

(52) U.S. Cl. CPC G05D 1/0088; G05D 1/0212

(57) ABSTRACT

A vehicle control device is provided with: a virtual waypoint arrangement unit that arranges, on a mapping space defined by a first axis extending in the length direction of a virtual lane and a second axis extending in the width direction, a candidate group of virtual waypoints along the first axis; and a mapping conversion unit that performs mapping conversion on at least a part of the candidate group by using mapping conversion information indicating a mapping relationship between a lane and the virtual lane so as to obtain a route point sequence which indicates the location of a travel trajectory on a real space.

### TECHNICAL FIELD

The present invention relates to a vehicle control apparatus (vehicle control device) that sequentially generates a travel trajectory for a vehicle and controls the vehicle based on the travel trajectory.

### BACKGROUND ART

Vehicle control apparatuses that sequentially generate a travel trajectory for a vehicle and control the vehicle based on the travel trajectory are known. For example, various techniques have been developed for generating a travel trajectory in consideration of the continuity of curvature and the continuity of curvature change rate.

Japanese Laid-Open Patent Publication No. 2010-073080 (paragraphs [0032] to [0037], for instance) proposes a method of generating a vehicle travel trajectory with introduction of switchback points where necessary such that input constraints are satisfied and the value of a cost function containing an element on the magnitude or change rate of a curve is minimized. Specifically, Japanese Laid-Open Patent Publication No. 2010-073080 describes finding individual via-points between an entry point (trajectory beginning point) and an exit point (trajectory end point) by the improved Dijkstra's algorithm and interpolating between neighboring ones of the via-points.

### SUMMARY OF INVENTION

However, the method proposed by Japanese Laid-Open Patent Publication No. 2010-073080 is intended for one-time generation of a travel trajectory and does not consider situations where the trajectory beginning and end points change over time. For example, when a lane to be traveled by the vehicle has a complicated shape, it is necessary to increase the number of via-points to be arranged for accurate representation of the travel trajectory shape. As a result, much computation time is required for finding possible combinations of via-points with a cost function, leading to loss of the real-time nature of travel control.

The present invention was made for solving such a problem, and an object thereof is to provide a vehicle control apparatus that is capable of accurately representing the position of a travel trajectory with reduced computation time regardless of the shape of the lane to be traveled by a vehicle.

A vehicle control apparatus according to the present invention is an apparatus that sequentially generates a travel trajectory for a vehicle and controls the vehicle based on the travel trajectory, and includes: a mapping transformation information creation unit configured to create mapping transformation information indicative of mapping relation between a lane in a real space to be traveled by the vehicle and a rectangular virtual lane in a mapping space; a virtual via-point arranging unit configured to arrange, on the mapping space defined by a first axis extending in a length direction of the virtual lane and a second axis extending in a width direction of the virtual lane, a candidate group of virtual via-points along the first axis; and a mapping transformation unit configured to obtain a route point sequence indicating a position of the travel trajectory in the real space by applying mapping transformation to at least some of the candidate group arranged by the virtual via-point arranging unit, using the mapping transformation information created by the mapping transformation information creation unit.

In this manner, a candidate group of virtual via-points are arranged along the first axis on the mapping space, which is defined by the length direction (the first axis) and the width direction (the second axis) of the rectangular virtual lane. This makes it possible to determine the positions or intervals of virtual via-points on the virtual lane, which has no curvature change, in accordance with relatively simple arrangement rules.

Then, by applying mapping transformation to at least some of the candidate group using mapping transformation information indicating the mapping relation between the lane in the real space and the virtual lane in the mapping space, the relative positional relationship among the via-points in the real space is maintained intact. This enables accurate representation of the position of the travel trajectory with reduced computation time regardless of the shape of the lane to be traveled by the vehicle.

The virtual via-point arranging unit may be configured to arrange the candidate group including subgroups of the virtual via-points that are identical in position in the first axis direction and different in position in the second axis direction. The vehicle can reach each of the virtual via-points that are identical in the position in the first axis direction substantially at the same time. By creating such subgroups of virtual via-points, a plurality of behavior patterns relating to the vehicle width direction at a certain future time can be prepared easily.

The virtual via-point arranging unit may be configured to arrange the candidate group including two or more subgroups that are different in a number or density of the virtual via-points. Virtual via-points can be arranged efficiently by paying attention to the fact that the reachable area for the vehicle in the second axis direction varies with elapsed time.

The virtual via-point arranging unit may be configured to arrange the candidate group including the two or more subgroups that contain more virtual via-points as the subgroups are closer to a position of the vehicle and less virtual via-points as they are farther from the position of the vehicle. Since the reachable area in the second axis direction expands with distance from the position of the vehicle, correspondingly lower positional resolution is required. By making use of this characteristic, the number of virtual via-points can be reduced in total.

The mapping transformation information creation unit may be configured to create the mapping transformation information indicative of a mapping relation that makes a centerline of the lane correspond to the first axis, and the virtual via-point arranging unit may be configured to arrange the candidate group in a manner that the virtual via-points are line-symmetric about the first axis and/or that the virtual via-points are equally spaced along the second axis. This can efficiently arrange virtual via-points near the centerline of the lane, which represents the travel target position for the vehicle.

The vehicle control apparatus may further include: a point sequence extraction unit configured to extract a sparse point sequence sequentially connected along the first axis from the candidate group; and an interpolation processing unit configured to obtain a dense point sequence encompassing the sparse point sequence by applying interpolation processing to the sparse point sequence extracted by the point sequence extraction unit. The mapping transformation unit may be configured to obtain the route point sequence by applying mapping transformation to the dense point sequence obtained by the interpolation processing unit.

The vehicle control apparatus may further include a smoothing processing unit configured to correct the position of the travel trajectory by performing smoothing processing on the route point sequence mapping-transformed by the mapping transformation unit. Depending on the characteristics of mapping transformation indicated by mapping transformation information, the continuity or smoothness of a curve may not be maintained intact through transformation. Thus, by performing smoothing processing on a route point sequence having received mapping transformation, the continuity or smoothness of the position of the travel trajectory in the real space can be ensured.

The vehicle control apparatus according to the present invention is capable of accurately representing the position of a travel trajectory with reduced computation time regardless of the shape of the lane to be traveled by a vehicle.

### BRIEF DESCRIPTION OF DRAWINGS

FIG. 1 is a block diagram showing a configuration of a vehicle control apparatus according to an embodiment of the present invention;

FIG. 2 is a functional block diagram of the middle-term trajectory generation unit shown in FIG. 1;

FIG. 3 is a flowchart for reference in description on the operation of the route candidate generation unit shown in FIG. 2;

FIG. 4 is a diagram schematically showing the correspondence between a real space in which a vehicle actually travels and a virtual mapping space;

FIG. 5 is a diagram describing how virtual via-points are arranged;

FIG. 6 is a diagram describing how virtual via-points are extracted;

FIG. 7 is a diagram showing an example of an execution result of interpolation processing;

FIG. 8 is a diagram showing an example of an execution result of mapping transformation; and

FIG. 9 is a diagram showing an example of an execution result of smoothing processing.

### DESCRIPTION OF EMBODIMENTS

The vehicle control apparatus according to the present invention is described below by showing preferred embodiments with reference to the accompanying drawings. [Configuration of Vehicle Control Apparatus 10]

### <Overall Configuration>

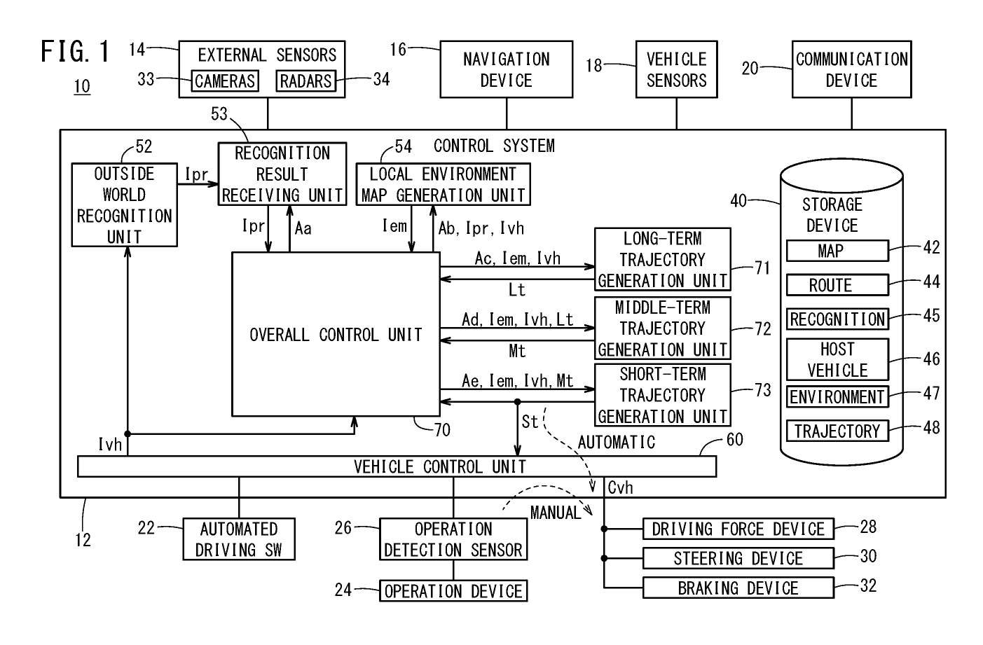

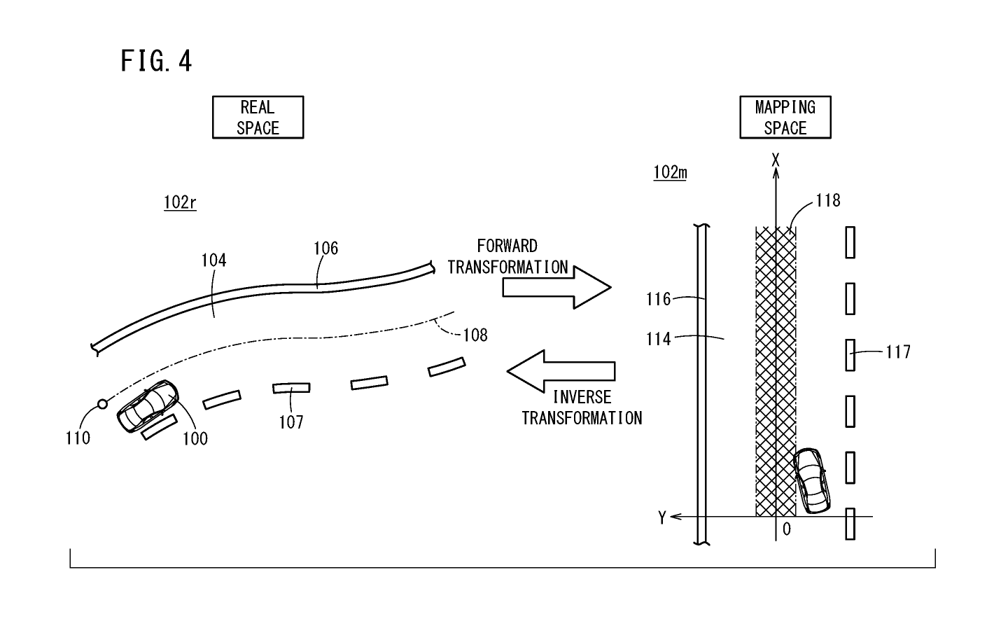

FIG. 1 is a block diagram showing a configuration of a vehicle control apparatus 10 according to an embodiment of the present invention. The vehicle control apparatus 10 is incorporated in a vehicle 100 (FIG. 4) and configured to be capable of executing automated driving of the vehicle 100 or automated driving assistance. The vehicle control apparatus 10 includes a control system 12, an input device, and an output device. The input device and the output device are each connected with the control system 12 through a communication line.

The input device includes external sensors 14, a navigation device 16, vehicle sensors 18, a communication device 20, an automated driving switch 22, and an operation detection sensor 26 connected with an operation device 24.

The output device includes a driving force device 28 for driving wheels (not shown), a steering device 30 for steering the wheels, and a braking device 32 for braking the wheels.

### <Specific Configuration of Input Device>

The external sensors 14 include a plurality of cameras 33 and a plurality of radars 34 for obtaining information indicating states outside the vehicle 100 (hereinafter outside information) and outputs the outside information obtained to the control system 12. The external sensors 14 may further include a plurality of LIDAR (Light Detection and Ranging, Laser Imaging Detection and Ranging) devices.

The navigation device 16 includes a satellite positioning device capable of detecting the current position of the vehicle 100, and user interfaces (for example, a touch panel display, a speaker, and a microphone). The navigation device 16 calculates a route to a specified destination based on the current position of the vehicle 100 or a user-specified position and outputs the route to the control system 12. The route calculated by the navigation device 16 is stored in a route information storage unit 44 of a storage device 40 as route information.

The vehicle sensors 18 include a speed sensor for detecting the speed of the vehicle 100 (the vehicle speed), an acceleration sensor for detecting an acceleration, a lateral acceleration sensor for detecting a lateral acceleration, a yaw rate sensor detecting an angular velocity about a vertical axis, an orientation sensor for detecting orientation or direction, and an inclination sensor for detecting an inclination, and outputs the detection signals from those sensors to the control system 12. The detection signals are stored in a host vehicle state information storage unit 46 of the storage device 40 as host vehicle state information Ivh.

The communication device 20 is configured to be capable of communication with external devices including roadside equipment, other vehicles, and servers, and sends and receives information on traffic equipment, information on other vehicles, probe information, or the latest map information, for example. The map information is stored in the navigation device 16 and also in a map information storage unit 42 of the storage device 40 as map information.

The operation device 24 includes an accelerator pedal, a steering wheel (a car steering wheel), a brake pedal, a shift lever, and a direction indication lever. The operation device 24 is equipped with the operation detection sensor 26 for detecting whether an operation is being performed by the driver or not, the amount of operation, and the position of operation.

The operation detection sensor 26 outputs the amount of accelerator pressing (accelerator opening), the amount of steering wheel operation (the amount of steering), the amount of brake pressing, the shift position, a right or left turn direction, and the like to a vehicle control unit 60 as detection results.

The automated driving switch 22 is, for example, a push button switch provided on an instrument panel for users including the driver to switch between a non-automated driving mode (manual driving mode) and an automated driving mode by manual operation.

In this embodiment, settings are such that the mode is switched between the automated driving mode and the non-automated driving mode every time the automated driving switch 22 is pressed. Alternatively, for more reliable confirmation of the driver's intention for automated driving, settings may be such that the mode switches from the non-automated driving mode to the automated driving mode when the automated driving switch 22 is pressed twice and from the automated driving mode to the non-automated driving mode when it is pressed once, for example.

The automated driving mode is a driving mode in which the vehicle 100 travels under control of the control system 12 without the driver manipulating the operation device 24 (specifically, the accelerator pedal, the steering wheel, and the brake pedal). In other words, the automated driving mode is a driving mode in which the control system 12 controls some or all of the driving force device 28, the steering device 30, and the braking device 32 based on a sequentially determined action plan (in a short term, a short-term trajectory St as discussed later).

If the driver starts manipulating the operation device 24 during the automated driving mode, the automated driving mode is automatically canceled to switch to the non-automated driving mode (manual driving mode).

### <Specific Configuration of Output Device>

The driving force device 28 is composed of a driving force electronic control unit (ECU) and a driving source including an engine and/or traction motor. The driving force device 28 generates travel driving force (torque) for the traveling of the vehicle 100 in accordance with a vehicle control value Cvh input from the vehicle control unit 60 and transmits the force to the wheels via a transmission or directly.

The steering device 30 is composed of an electric power steering system (EPS) ECU and an EPS device. The steering device 30 changes the orientation of the wheels (drive wheels) in accordance with the vehicle control value Cvh input from the vehicle control unit 60.

The braking device 32 is an electric servo brake used in conjunction with a hydraulic brake, for example, and is composed of a brake ECU and a brake actuator. The braking device 32 brakes the wheels in accordance with the vehicle control value Cvh input from the vehicle control unit 60.

### <Configuration of Control System 12>

The control system 12 is composed of one or more ECUs and includes various functional components as well as the storage device 40 and the like. The functional components in this embodiment are software functional components whose functions are implemented by execution of programs stored in the storage device 40 by a central processing unit (CPU); however, they may be implemented in hardware functional components composed of an integrated circuit and the like.

The control system 12 includes, in addition to the storage device 40 and the vehicle control unit 60, an outside world recognition unit 52, a recognition result receiving unit 53, a local environment map generation unit 54, an overall control unit 70, a long-term trajectory generation unit 71, a middle-term trajectory generation unit 72, and a short-term trajectory generation unit 73. The overall control unit 70 centrally controls the individual units by controlling task synchronization among the recognition result receiving unit 53, the local environment map generation unit 54, the long-term trajectory generation unit 71, the middle-term trajectory generation unit 72, and the short-term trajectory generation unit 73.

The outside world recognition unit 52, with reference to the host vehicle state information Ivh from the vehicle control unit 60, recognizes lane marking (white lines) on the opposite sides of the vehicle 100 based on outside information (including image information) from the external sensors 14, and generates “static” outside world recognition information, including the distance to a stop line and a travel-available region. The outside world recognition unit 52 also generates “dynamic” outside world recognition information such as on obstacles (including parked or stopped vehicles), traffic participants (persons and other vehicles), and traffic light colors {blue (green), yellow (orange), red}, based on outside information from the external sensors 14.

The outside world recognition unit 52 outputs (sends) the generated static and dynamic outside world recognition information (sometimes collectively called “outside world recognition information Ipr” below) to the recognition result receiving unit 53. At the same time, the outside world recognition information Ipr is stored in an outside world recognition information storage unit 45 of the storage device 40.

The recognition result receiving unit 53, in response to a computation command Aa, outputs the outside world recognition information Ipr it has received within a predetermined computation cycle Toc (the reference cycle or reference computation cycle) to the overall control unit 70 with the count value of an update counter. The computation cycle Toc is the reference computation cycle within the control system 12, being set to a value on the order of several tens ms, for example.

The local environment map generation unit 54, in response to a computation command Ab from the overall control unit 70, generates local environment map information Iem within the computation cycle Toc with reference to the host vehicle state information Ivh and outside world recognition information Ipr, and outputs the local environment map information Iem to the overall control unit 70 with the count value of an update counter. That is to say, at the start of control, a computation cycle of 2×Toc is required before the local environment map information Iem is generated.

Roughly speaking, the local environment map information Iem is information that combines the host vehicle state information Ivh with the outside world recognition information Ipr. The local environment map information Iem is stored in a local environment map information storage unit 47 of the storage device 40.

The long-term trajectory generation unit 71, in response to a computation command Ac from the overall control unit 70, generates a long-term trajectory Lt in a relatively longest computation cycle (for example, 9×Toc) with reference to the local environment map information Iem (utilizing only the static components of the outside world recognition information Ipr), the host vehicle state information Ivh, and a road map (for example, the curvatures of curves) stored in the map information storage unit 42. Then, the long-term trajectory generation unit 71 outputs the generated long-term trajectory Lt to the overall control unit 70 with the count value of an update counter. The long-term trajectory Lt is stored in a trajectory information storage unit 48 of the storage device 40 as trajectory information.

The middle-term trajectory generation unit 72, in response to a computation command Ad from the overall control unit 70, generates a middle-term trajectory Mt within a relatively medium computation cycle (for example, 3×Toc) with reference to the local environment map information Iem (utilizing both the dynamic and static components of the outside world recognition information Ipr), the host vehicle state information Ivh, and the long-term trajectory Lt. Then, the middle-term trajectory generation unit 72 outputs the generated middle-term trajectory Mt to the overall control unit 70 with the count value of an update counter. The middle-term trajectory Mt is stored in the trajectory information storage unit 48 as trajectory information like the long-term trajectory Lt.

The short-term trajectory generation unit 73, in response to a computation command Ae from the overall control unit 70, generates a short-term trajectory St within a relatively shortest computation cycle (for example, Toc) with reference to the local environment map information Iem (utilizing both the dynamic and static components of the outside world recognition information Ipr), the host vehicle state information Ivh, and the middle-term trajectory Mt. Then, the short-term trajectory generation unit 73 outputs the generated short-term trajectory St to the overall control unit 70 and to the vehicle control unit 60 simultaneously with the count value of an update counter. The short-term trajectory St is stored in the trajectory information storage unit 48 as trajectory information like the long-term trajectory Lt and middle-term trajectory Mt.

The long-term trajectory Lt indicates a trajectory for a traveling time of, for example, about 10 seconds, a trajectory that gives priority to the ride quality and comfort. The short-term trajectory St indicates a trajectory for a traveling time of, for example, about 1 second, a trajectory that gives priority to the achieving of vehicle dynamics and ensuring of safety. The middle-term trajectory Mt indicates a trajectory for a traveling time of, for example, about 5 seconds, an intermediate trajectory relative to the long-term trajectory Lt and the short-term trajectory St.

The short-term trajectory St is equivalent to a data set indicative of the target behavior of the vehicle 100 per short cycle Ts (=Toc). The short-term trajectory St is a trajectory point sequence (x, y, θz, Vs, Va, ρ, γ, δst) with the data unit being position x in the vertical direction (X-axis), position y in the lateral direction (Y-axis), attitude angle θz, speed Vs, acceleration Va, curvature ρ, yaw rate γ, and steering angle δst, for example. The long-term trajectory Lt or the middle-term trajectory Mt is a data set defined in a similar manner to the short-term trajectory St, though with a different cycle.

The vehicle control unit 60 determines a vehicle control value Cvh that allows traveling of the vehicle 100 according to behaviors identified with the short-term trajectory St (a trajectory point sequence) and outputs the resulting vehicle control value Cvh to the driving force device 28, the steering device 30, and the braking device 32.

### [Configuration and Operation of Middle-Term Trajectory Generation Unit 72]

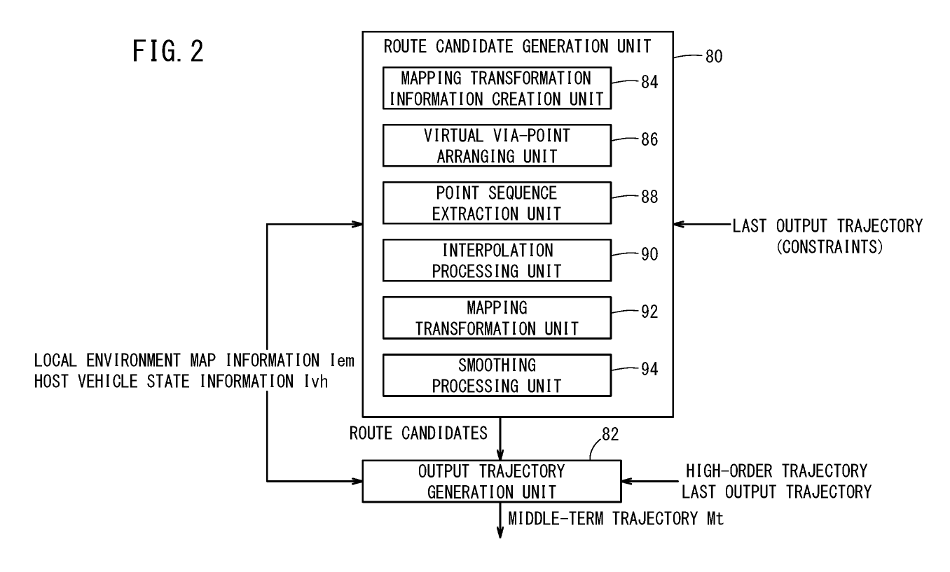

The vehicle control apparatus 10 in this embodiment is configured as described above. Next, the configuration and operation of the middle-term trajectory generation unit 72 are described in detail with reference to FIGS. 2 to 9.

### <Functional Block Diagram of Middle-Term Trajectory Generation Unit 72>

FIG. 2 is a functional block diagram of the middle-term trajectory generation unit 72 shown in FIG. 1. The middle-term trajectory generation unit 72 includes a route candidate generation unit 80 for generating route candidates, and an output trajectory generation unit 82 for selecting a desired route from the route candidates and generating an output trajectory (here, middle-term trajectory Mt).

The route candidate generation unit 80 generates candidates for a point sequence (x, y) which the vehicle 100 should pass through (that is, route candidates) using the local environment map information Iem, the host vehicle state information Ivh, and the last output trajectory (specifically, the most recently generated middle-term trajectory Mt). The route candidate generation unit 80 includes a mapping transformation information creation unit 84, a virtual via-point arranging unit 86, a point sequence extraction unit 88, an interpolation processing unit 90, a mapping transformation unit 92, and a smoothing processing unit 94.

The output trajectory generation unit 82 generates the latest middle-term trajectory Mt using the route candidates generated by the route candidate generation unit 80 as well as the local environment map information Iem, a high-order trajectory (specifically, the long-term trajectory Lt), and the last output trajectory (the most recent middle-term trajectory Mt). Specifically, the output trajectory generation unit 82 generates trajectory candidates by combing a speed pattern with each of the route candidates and outputs the trajectory having the highest evaluation result upon a predefined evaluation criterion as the middle-term trajectory Mt.

### <Operation of Route Candidate Generation Unit 80>

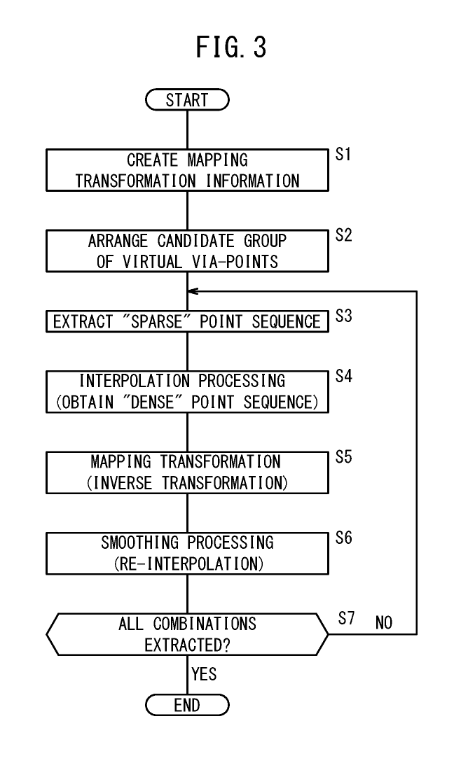

Next, the specific operation of the route candidate generation unit 80 is described in detail with reference to the flowchart of FIG. 3 and FIGS. 4 to 9.

At step S1 in FIG. 3, the mapping transformation information creation unit 84 creates mapping transformation information indicative of the mapping relation between a lane 104 in a real space 102r to be traveled by the vehicle 100 and a virtual lane 114 in a mapping space 102m.

FIG. 4 is a diagram schematically showing the correspondence between the real space 102r in which the vehicle 100 actually travels and the virtual mapping space 102m. In the real space 102r, the vehicle 100 is traveling on the lane 104 of a meandering shape. The lane 104 is partitioned by a lane marking 106 in the form of a continuous line and a lane marking 107 in the form of a broken line. The dot dashed-line shown in this diagram represents a centerline 108 of the lane 104.

Meanwhile, the mapping space 102m is a planar space produced by applying certain mapping transformation (specifically, mapping transformation that makes the centerline 108 of the lane 104 correspond to a single coordinate axis) to the real space 102r. As a result, the lane 104 in the real space 102r is converted to the rectangular virtual lane 114 in the mapping space 102m. The mapping space 102m is defined by an X-axis (a first axis) extending in the length direction of the virtual lane 114 and a Y-axis (a second axis) extending in the width direction of the virtual lane 114.

An origin O of the mapping space 102m corresponds to a reference point 110 located near the vehicle 100 and on the centerline 108. A virtual lane marking 116 is substantially linear and corresponds to the lane marking 106. A virtual lane marking 117 is substantially linear and corresponds to the lane marking 107.

The double-hatched, strip-shaped region is an area in which virtual candidate points discussed below are arranged (hereinafter an arrangement region 118). The arrangement region 118 has a shape extending along the X-axis and being line-symmetric about the X-axis.

For the following description, mapping transformation from the real space 102r to the mapping space 102m is defined as “forward transformation”, while mapping transformation from the mapping space 102m to the real space 102r is defined as “inverse transformation”. This mapping transformation may be well-known reversible transformation with complete or substantial reversibility. Mapping transformation information is information that can identify a certain mapping transformation model; specifically, it may be matrix elements for identifying a matrix, or coefficients for identifying a function type.

At step S2, the virtual via-point arranging unit 86 arranges a candidate group 120 of virtual via-points on the mapping space 102m defined at step S1. “Virtual via-points” are points that virtually indicate positions to be passed through by the vehicle 100 in the mapping space 102m.

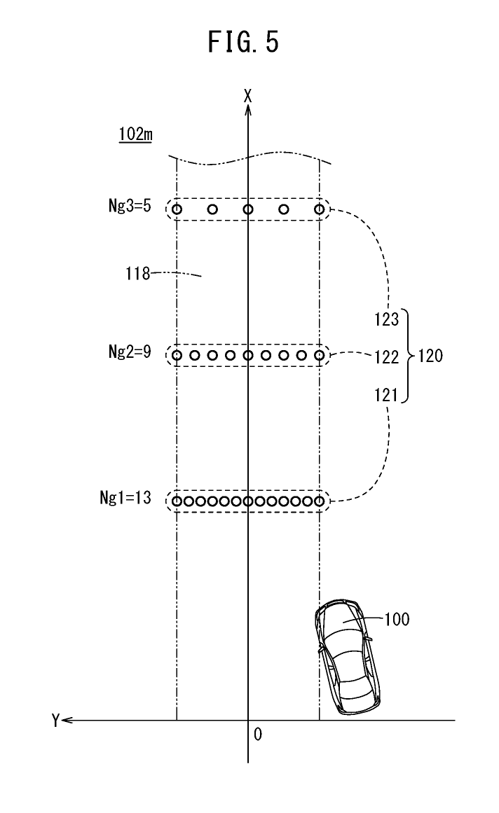

As shown in FIG. 5, the plurality of virtual candidate points forming the candidate group 120 are all arranged in the arrangement region 118. The candidate group 120 consists of three subgroups 121, 122, 123, classified according to the positions in the X-axis direction (also called “X-position” hereinbelow).

The subgroup 121 consists of 13 (Ng1=13) virtual via-points arranged at positions relatively close to the vehicle 100. These virtual via-points are identical in the X-position (including the case of “identical within an acceptable range”, which applies to the following) and different in the position in the Y-axis direction (also called “Y-position” hereinbelow). Here, the individual virtual via-points are arranged such that they are line-symmetric about the X-axis and are equally spaced along the Y-axis (including the case of “equally spaced within an acceptable range”, which applies to the following).

The subgroup 122 consists of nine (Ng2=9) virtual via-points arranged at a relatively medium distance to the vehicle 100. These virtual via-points are identical in the X-position and different in the Y-position. Here, the individual virtual via-points are arranged such that they are line-symmetric about the X-axis and equally spaced along the Y-axis.

The subgroup 123 consists of five (Ng3=5) virtual via-points arranged at positions relatively far from the vehicle 100. These virtual via-points are identical in the X-position and different in the Y-position. Here, the individual virtual via-points are arranged such that they are line-symmetric about the X-axis and equally spaced along the Y-axis.

The X-positions of the subgroups 121 to 123 may be determined based on the host vehicle state information Ivh (the speed of the vehicle 100 in particular). For example, assuming that the vehicle 100 at the origin O travels at a constant speed, the subgroups 121, 122, and 123 are arranged at X-positions that the vehicle 100 can reach in 3, 5, and 7 seconds, respectively.

In this way, the virtual via-point arranging unit 86 may arrange the candidate group 120 including the subgroups 121 to 123 of virtual via-points that are identical in the X-position and different in the Y-position. The vehicle 100 can reach each of the virtual via-points that are identical in the X-position substantially at the same time. By creating such subgroups 121 to 123 of virtual via-points, a plurality of behavior patterns relating to the vehicle width direction at a certain future time can be prepared easily.

The virtual via-point arranging unit 86 may also arrange a candidate group 120 including two or more subgroups 121 to 123 that are different in the number or density of virtual via-points. Virtual via-points can be arranged efficiently by paying attention to the fact that the reachable area for the vehicle 100 in the Y-axis direction varies with elapsed time.

The virtual via-point arranging unit 86 may also arrange a candidate group 120 including two or more subgroups 121 to 123 that contain more virtual via-points as they are closer to the position of the vehicle 100 and less virtual via-points as they are farther from the position of the vehicle 100 (Ng1>Ng2>Ng3). Since the reachable area in the Y-axis direction expands with distance from the position of the vehicle 100, correspondingly lower positional resolution is required. By making use of this characteristic, the number of virtual via-points can be reduced in total.

The virtual via-point arranging unit 86 may also arrange the candidate group 120 such that the virtual via-points are line-symmetric about the X-axis, which corresponds to the centerline 108 of the lane 104, and/or such that the virtual via-points are equally spaced along the Y-axis. This can efficiently arrange virtual via-points near the centerline 108, which represents the travel target position for the vehicle 100.

At step S3, the point sequence extraction unit 88 extracts a “sparse” point sequence 130 sequentially connected along the X-axis from the candidate group 120 that were arranged at step S2.

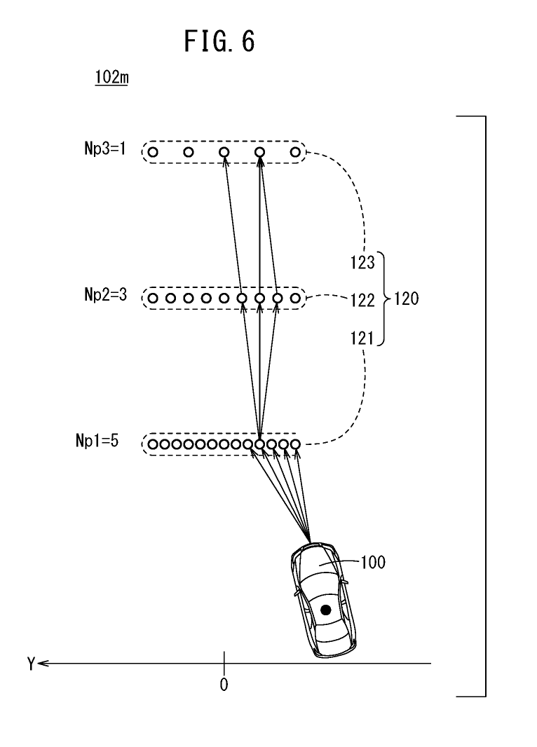

As shown in FIG. 6, the point sequence extraction unit 88 selects one virtual via-point from each of the three subgroups 121 to 123, thereby extracting a point sequence 130 consisting of a total of four points, including the position of the vehicle 100. Although a maximum of 585 patterns (=13×9×5) can be extracted as the combinations in the point sequence 130, the point sequence extraction unit 88 limits extraction to 15 patterns, significantly less than the total number of possible combinations, according to the positional relation to the vehicle 100.

In the subgroup 121, five (Np1=5) virtual via-points are preferentially selected in ascending order of the difference value (the absolute value of deviation) in the Y-position from the vehicle 100. As a result, five points, the first to fifth points from the right (the negative Y-axis direction), are extracted.

In the subgroup 122, three (Np2=3) virtual via-points are preferentially selected in ascending order of the difference value (the absolute value of deviation) in the Y-position from a virtual via-point belonging to the subgroup 121. For example, with respect to the fourth virtual via-point from the right (in the subgroup 121), three points, the second to fourth points from the right (the negative Y-axis direction), are extracted.

In the subgroup 123, one (Np3=1) virtual via-point is preferentially selected in ascending order of the difference value (the absolute value of deviation) in the Y-position from a virtual via-point belonging to the subgroup 122. For example, with respect to the second and third virtual via-points from the right (in the subgroup 122), one point, the second point from the right (the negative Y-axis direction), is extracted. Likewise, with respect to the fourth virtual via-point from the right (in the subgroup 122), one point, the third point from the right (the negative Y-axis direction), is extracted.

The point sequence extraction unit 88 determines: 1 (for the vehicle 100)×5 (for the subgroup 121)×3 (for the subgroup 122)×1 (for the subgroup 123)=15 patterns of point sequence 130, among the 585 possible combinations. Out of the 15 patterns, the point sequence extraction unit 88 selects one point sequence 130 that has not been extracted yet.

In this manner, the point sequence extraction unit 88 may extract different numbers of virtual via-points from each of two or more subgroups 121 to 123. Virtual via-points can be extracted efficiently by paying attention to the fact that the reachable area for the vehicle 100 in the Y-axis direction varies with elapsed time.

The point sequence extraction unit 88 may also extract, as virtual candidate points, more virtual via-points as they are closer to the position of the vehicle 100 and less virtual via-points as they are farther from the position of the vehicle 100 from the two or more subgroups 121 to 123 (Np1>Np2>Np3). As the positional resolution corresponding to the virtual via-points belonging to the subgroups 121 to 123 is lower, a smaller number of virtual via-points have to be extracted. By making use of this characteristic, the total number of possible combinations for the point sequence 130 that should be extracted as route candidates can be reduced.

At step S4, the interpolation processing unit 90 obtains a “dense” point sequence 132 encompassing the point sequence 130 by applying interpolation processing to the “sparse” point sequence 130 extracted at step S3.

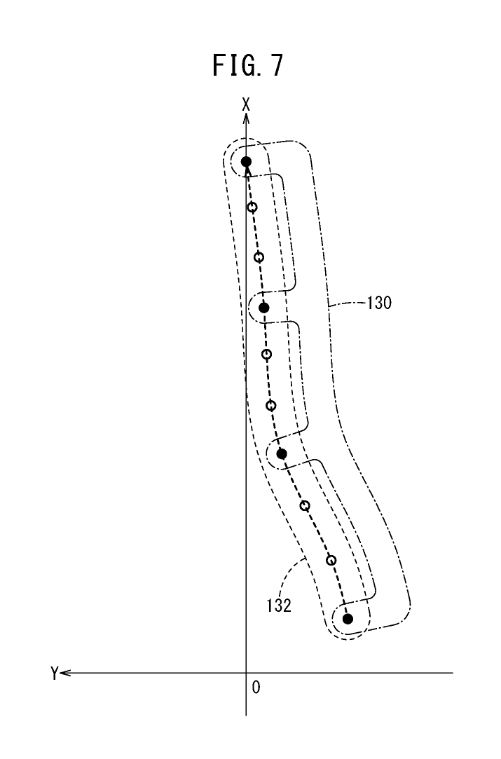

In the example shown in FIG. 7, the relatively sparse point sequence 130 consists of the four points indicated as filled circles (●). By interpolating the point sequence 130 with a certain interpolation curve including a spline curve, a Bezier curve, and a Lagrange curve, a virtual curved route (shown as broken line) on the mapping space 102m is determined. The relatively dense point sequence 132 consists of a total of ten points, that is, the four points forming the point sequence 130 and the six points indicated as unfilled circles (◯).

At step S5, the mapping transformation unit 92 obtains a route point sequence 134 by applying mapping transformation to the “dense” point sequence 132 obtained at step S4, using the mapping transformation information created at step S1. It is noted that here the mapping transformation unit 92 performs the “inverse transformation” shown in FIG. 4 as the mapping transformation.

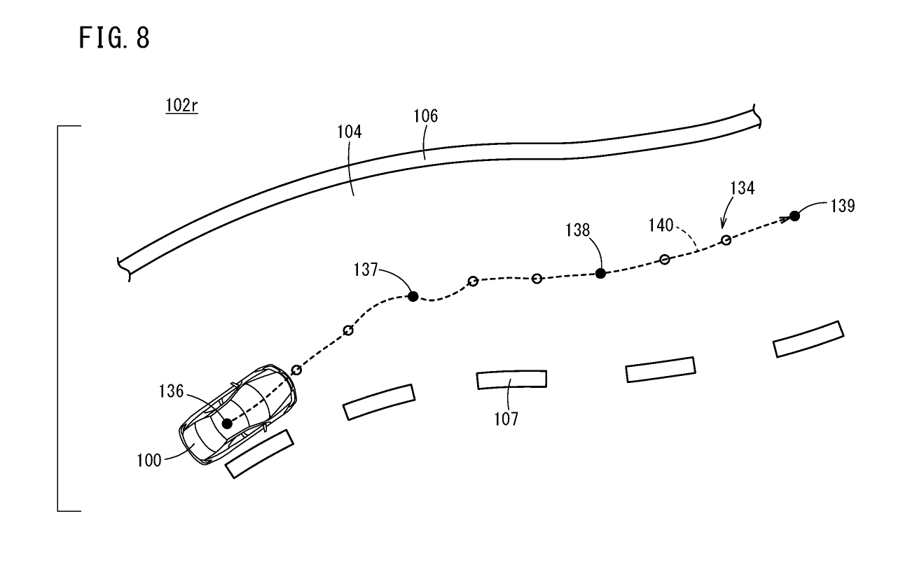

As shown in FIG. 8, a plot to indicate the position of the route point sequence 134 is drawn on the lane 104. Via-points 136 to 139 correspond to the point sequence 130 on the mapping space 102m, indicating the position of a curved route 140 (shown as broken line). “Via-points” are points that indicate positions in the real space 102r to be passed through by the vehicle 100.

Depending on the characteristics of mapping transformation indicated by mapping transformation information, the continuity or smoothness of a curve may not be maintained intact through transformation. For instance, in the example of this diagram, the smoothness of the curved route 140 is impaired in the sections around a via-point 137, which has a relatively large curvature (a relatively small radius of curvature).

At step S6, the smoothing processing unit 94 corrects the position of the middle-term trajectory Mt by performing smoothing processing on the route point sequence 134 having received mapping transformation at step S5. Specifically, the smoothing processing unit 94 performs so-called “re-interpolation processing”, which involves re-sampling on the curved route 140 and then applying interpolation processing to the resulting point sequence (a point sequence which is the same as or different from the route point sequence 134). In the re-interpolation processing, interpolation processing which is the same as or different from that at step S4 may be performed.

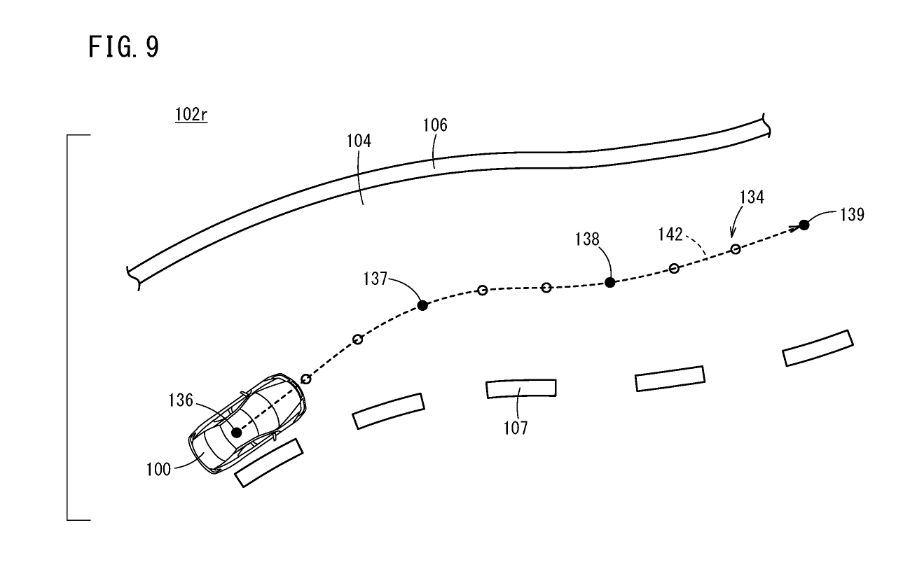

As shown in FIG. 9, a corrected curved route 142 has a smooth shape in all of the sections, including the sections around the via-point 137. In this manner, by performing smoothing processing on the route point sequence 134 having received mapping transformation, the continuity or smoothness of the position of the middle-term trajectory Mt (travel trajectory) in the real space 102r can be ensured.

At step S7, the route candidate generation unit 80 determines whether the route point sequence 134 has been obtained for all of combinations of the point sequence 130 extracted. If it is not complete (step S7: NO), the flow returns to step S3 and steps S3 to S7 are sequentially repeated until it is complete for all of the combinations.

On the other hand, if it is complete for all of the combinations of the point sequence 130 (step S7: YES), the route candidate generation unit 80 ends the route candidate generating operation and provides the route candidates to the output trajectory generation unit 82.

### [Effects of Vehicle Control Apparatus 10]

As described above, the vehicle control apparatus 10 is [1] an apparatus that sequentially generates a middle-term trajectory Mt (travel trajectory) for a vehicle 100 and controls the vehicle 100 based on the middle-term trajectory Mt, and includes [2] a mapping transformation information creation unit 84 configured to create mapping transformation information indicative of mapping relation between a lane 104 in a real space 102r to be traveled by the vehicle 100 and a rectangular virtual lane 114 in a mapping space 102m, [3] a virtual via-point arranging unit 86 configured to arrange, on the mapping space 102m defined by an X-axis (first axis) extending in a length direction of the virtual lane 114 and a Y-axis (second axis) extending in a width direction, a candidate group 120 of virtual via-points along the X-axis, and [4] a mapping transformation unit 92 configured to obtain a route point sequence 134 indicating a position of the middle-term trajectory Mt in the real space 102r by applying mapping transformation to at least some of the candidate group 120 arranged, using the created mapping transformation information.

In this manner, the candidate group 120 of virtual via-points are arranged along the X-axis on the mapping space 102m, which is defined by the length direction (the X-axis) and the width direction (the Y-axis) of the rectangular virtual lane 114. This makes it possible to determine the positions or intervals of virtual via-points on the virtual lane 114, which has no curvature change, in accordance with relatively simple arrangement rules.

Then, by applying mapping transformation to at least some of the candidate group 120 using mapping transformation information indicating the mapping relation between the lane 104 in the real space 102r and the virtual lane 114 in the mapping space 102m, the relative positional relationship among the via-points in the real space 102r is maintained intact. This enables accurate representation of the position of the middle-term trajectory Mt with reduced computation time regardless of the shape of the lane 104 to be traveled by the vehicle 100.

The vehicle control apparatus 10 may further include [5] a point sequence extraction unit 88 configured to extract a sparse point sequence 130 sequentially connected along the X-axis from the candidate group 120, and [6] an interpolation processing unit 90 configured to obtain a dense point sequence 132 encompassing the point sequence 130 by applying interpolation processing to the sparse point sequence 130 extracted. In this case, [7] the mapping transformation unit 92 may be configured to obtain the route point sequence 134 by applying mapping transformation to the dense point sequence 132 obtained by the interpolation processing.

### [Supplementary Note]

It will be apparent that the present invention is not limited to the above embodiment but may be subjected to any modification as desired without departing from the scope of the invention.

For example, although the virtual via-point arranging unit 86 in this embodiment arranges the candidate group 120 shown in FIG. 5, the number, positions, intervals, and arrangement of candidate via-points, the number of subgroups, and the number of candidate via-points belonging to each subgroup may be modified as desired.

Although the mapping transformation unit 92 in this embodiment applies mapping transformation to the virtual via-points extracted by the point sequence extraction unit 88 (some of the candidate group 120), the present invention is not limited thereto. For example, the point sequence extraction unit 88 may be omitted and the mapping transformation unit 92 may perform mapping transformation on all of the virtual via-points arranged by the virtual via-point arranging unit 86 (the entire candidate group 120).

Although the mapping transformation unit 92 in this embodiment applies mapping transformation to the point sequence 132 interpolated by the interpolation processing unit 90 (a point sequence encompassing the point sequence 130), the present invention is not limited thereto. For example, the interpolation processing unit 90 may be omitted and mapping transformation may be performed directly on a point sequence produced by sequentially connecting the virtual via-points arranged by the virtual via-point arranging unit 86.

1. A vehicle control apparatus that sequentially generates a travel trajectory for a vehicle and controls the vehicle based on the travel trajectory, the vehicle control apparatus comprising:
a mapping transformation information creation unit configured to create mapping transformation information indicative of mapping relation between a lane in a real space to be traveled by the vehicle and a rectangular virtual lane in a mapping space;
a virtual via-point arranging unit configured to arrange, on the mapping space defined by a first axis extending in a length direction of the virtual lane and a second axis extending in a width direction of the virtual lane, a candidate group of virtual via-points along the first axis; and
a mapping transformation unit configured to obtain a route point sequence indicating a position of the travel trajectory in the real space by applying mapping transformation to at least some of the candidate group arranged by the virtual via-point arranging unit, using the mapping transformation information created by the mapping transformation information creation unit.

2. The vehicle control apparatus according to claim 1, wherein the virtual via-point arranging unit is configured to arrange the candidate group including subgroups of the virtual via-points that are identical in position in the first axis direction and different in position in the second axis direction.

3. The vehicle control apparatus according to claim 2, wherein the virtual via-point arranging unit is configured to arrange the candidate group including two or more subgroups that are different in a number or density of the virtual via-points.

4. The vehicle control apparatus according to claim 3, wherein the virtual via-point arranging unit is configured to arrange the candidate group including the two or more subgroups that contain more virtual via-points as the subgroups are closer to a position of the vehicle and less virtual via-points as they are farther from the position of the vehicle.

5. The vehicle control apparatus according to claim 1, wherein the mapping transformation information creation unit is configured to create the mapping transformation information indicative of a mapping relation that makes a centerline of the lane correspond to the first axis, and
the virtual via-point arranging unit is configured to arrange the candidate group in a manner that the virtual via-points are line-symmetric about the first axis and/or that the virtual via-points are equally spaced along the second axis.

6. The vehicle control apparatus according to claim 1, further comprising:
a point sequence extraction unit configured to extract a sparse point sequence sequentially connected along the first axis from the candidate group; and
an interpolation processing unit configured to obtain a dense point sequence encompassing the sparse point sequence by applying interpolation processing to the sparse point sequence extracted by the point sequence extraction unit,
wherein the mapping transformation unit is configured to obtain the route point sequence by applying mapping transformation to the dense point sequence obtained by the interpolation processing unit.

7. The vehicle control apparatus according to claim 6, further comprising a smoothing processing unit configured to correct the position of the travel trajectory by performing smoothing processing on the route point sequence transformed by the mapping transformation unit.
